(19) United States
(12) Patent Application Publication
(10) Pub. No.: US 2023/0242772 A1
(43) Pub. Date: Aug. 3, 2023

(54) RETROREFLECTIVE COATING COMPOSITIONS, COATINGS FORMED THEREFROM, AND METHODS OF FORMING SUCH COATINGS

(71) Applicant: PPG Industries Ohio, Inc., Cleveland, OH (US)

(72) Inventors: Paul William Bradley, Corinth, TX (US); James William Stuck, Gainesville, TX (US); Travis Owen Bush, Valley View, TX (US)

(73) Assignee: PPG Industries Ohio, Inc., Cleveland, OH (US)

(21) Appl. No.: 17/996,650

(22) PCT Filed: Apr. 20, 2021
(86) PCT No.: PCT/US2021/028111

§ 371 Date: Oct. 20, 2022

Related U.S. Application Data
(60) Provisional application No. 63/013,174, filed on Apr. 21, 2020.

(51) Int. Cl. C09D 5/03; C09D 7/62; C09D 167/06; C09D 7/65

(52) U.S. Cl. CPC C09D 5/032; C09D 7/62; C09D 7/65; C09D 167/06

(57) ABSTRACT

The present invention relates to a retroreflective powder coating composition that includes: (a) a binder including a film-forming resin; and (b) a plurality of particles in which at least a portion of the particles include particles at least partially coated with a metallic material. The coating composition has a glass plate flow of 40 mm or less before addition of the plurality of particles, and/or at least portion of the particles are further coated with an additional material that lowers a surface energy of the particles. A method of forming a coating is also disclosed.

### FIELD OF THE INVENTION

The present invention relates to retroreflective coating compositions, substrates at least partially coated with such compositions, and methods of forming coatings.

### BACKGROUND OF THE INVENTION

Retroreflective coatings are applied to substrates so that the substrates are more visible under low light conditions. Particularly, when applied over a surface of the substrate, retroreflective coatings reflect incident light back in the direction of the light source such that the substrate is more visible to an individual observing the substrate. Because retroreflective coatings improve the visibility of objects under low light conditions (e.g. at night), these coatings are typically applied over traffic signs, road markings, bicycles, automotive components, and the like to reflect incident light from headlights of oncoming vehicles back to the driver, thereby improving visibility of the coated components.

Considerable efforts have been expended in developing retroreflective coatings that provide desirable retroreflective properties. However, while various retroreflective coatings have been developed, there is still a need for robust and easy to use retroreflective powder coatings. As such, it is desirable to provide robust and easy to use retroreflective powder coatings.

### SUMMARY OF THE INVENTION

The present invention is directed to a retroreflective powder coating composition comprising: (a) a binder comprising a film-forming resin; and (b) a plurality of particles in which at least a portion of the particles comprise particles at least partially coated with a metallic material. The coating composition has a glass plate flow of 40 mm or less before addition of the plurality of particles, and/or at least portion of the particles are further coated with an additional material that lowers a surface energy of the particles.

The present invention also includes a substrate at least partially coated with a coating formed from the retroreflective coating composition.

The present invention is also directed to a method of forming a coating over at least a portion of a substrate comprising: (a) applying a coating composition as previously described such that the binder and plurality of particles are applied together over the substrate during step (a); and (b) curing the coating composition after step (a) to form a coating. The coating exhibits a coefficient of retroreflection (R_{A}) of at least 3.5 cd/fc/ft² in accordance with ASTM E1709-08 with an observation angle of 0.2° and entrance angle of -4°.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” film-forming resin, “a” particle, and the like refer to one or more of any of these items.

As indicated, the present invention is directed to a retroreflective powder coating composition. As used herein, the term “retroreflective” refers to the ability of a component or material to reflect incident light back in the direction of the light source. Further, a “powder coating composition” refers to a coating composition embodied in solid particulate form as opposed to liquid form. The powder coating composition can comprise a solid particulate powder coating composition that is free flowing. As used herein, the term “free flowing” with regard to a solid particulate powder coating composition refers a solid particulate powder composition having a minimum of clumping or aggregation between individual particles.

The powder coating composition of the present invention includes a binder. As used herein, a “binder” refers to a main constituent material that holds all components together upon curing of the curable coating composition applied to a substrate. The binder includes one or more, such as two or more, film-forming resins. As used herein, a “film-forming resin” refers to a resin that can form a self-supporting continuous film on at least a horizontal surface of a substrate upon removal of any diluents or carriers present in the composition or upon curing. Further, as used herein, the term “resin” is used interchangeably with “polymer,” and the term polymer refers to oligomers and homopolymers (e.g., prepared from a single monomer species), copolymers (e.g., prepared from at least two monomer species), terpolymers (e.g., prepared from at least three monomer species), and graft polymers.

The powder coating compositions used with the present invention can include a variety of thermosetting powder coating compositions known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured, a thermosetting resin will not melt upon the application of heat and is insoluble in solvents.

The powder coating compositions used with the present invention can also include thermoplastic powder coating compositions. As used herein, the term “thermoplastic” refers to compositions that include polymeric components that are not joined by covalent bonds and, thereby, can undergo liquid flow upon heating.

Non-limiting examples of suitable film-forming resins include (meth)acrylate resins, polyurethanes, polyesters, polyamides, polyethers, polysiloxanes, epoxy resins, vinyl resins, copolymers thereof, and combinations thereof. As used herein, “(meth)acrylate” and like terms refers both to the acrylate and the corresponding methacrylate. Further, the film-forming resins can have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), and combinations thereof.

Thermosetting coating compositions typically comprise a crosslinker that may be selected from any of the crosslinkers known in the art to react with the functionality of one or more film-forming resins used in the powder coating composition. The binder may therefore also include a crosslinker. As used herein, the term “crosslinker” refers to a molecule comprising two or more functional groups that are reactive with other functional groups and that is capable of linking two or more monomers or polymers through chemical bonds. Alternatively, the film-forming resins that form the binder of the powder coating composition can have functional groups that are reactive with themselves; in this manner, such resins are self-crosslinking.

Non-limiting examples of crosslinkers include phenolic resins, amino resins, epoxy resins, triglycidyl isocyanurate, beta-hydroxy (alkyl) amides, alkylated carbamates, (meth)acrylates, isocyanates, blocked isocyanates, triglycidyl isocyanurates, polyacids, anhydrides, organometallic acid-functional materials, polyamines, polyamides, aminoplasts, carbodiimides, oxazolines, and combinations thereof. The blocked isocyanate crosslinker may comprise an internally blocked isocyanate (e.g., a uretdione). The blocked isocyanate may comprise an isocyanate blocked with an external blocking agent.

It is appreciated that the binder can comprise various types of film-forming resins and optionally crosslinkers including any of the film-forming resins and optional crosslinkers previously described. For example, the film-forming resin can comprise a carboxylic acid functional polyester, and the crosslinker can comprise an epoxy functional addition polymer. For example, the film-forming resin can comprise a hydroxyl functional polyester, and the crosslinker can comprise a blocked isocyanate (thus forming a polyurethane polymer by the crosslinking reaction). For example, the film-forming resin can comprise a polyester polymer and the crosslinker can comprise a triglycidyl isocyanurate crosslinker, a hydroxyalkyl amide crosslinker (e.g., a beta-hydroxy (alkyl) amide crosslinker), a glycidyl functional acrylic copolymer crosslinker, or a combination thereof. For example, the film-forming resin can comprise an epoxy, a polyester and epoxy blend (e.g., comprising both a polyester polymer and separate epoxy polymer, such as a carboxylic acid functional polyester reactive with the separate epoxy polymer), a fluoropolymer, a silicone-containing polymer, or a combination thereof, and can comprise a suitable crosslinker reactive with the film-forming resin. For example, the film-forming resin can comprise an epoxy functional resin and a phenolic crosslinker.

As used herein, an “addition polymer” refers to a polymer at least partially derived from ethylenically unsaturated monomers. The term “ethylenically unsaturated” refers to a group having at least one carbon-carbon double bond. Non-limiting examples of ethylenically unsaturated groups include, but are not limited to, (meth)acrylate groups, vinyl groups, other alkenes, and combinations thereof.

The binder can comprise at least 10 weight%, at least 20 weight, or at least 30 weight % of the coating composition, based on the total solids weight of the coating composition. The binder can also comprise 70 weight% or less, 60 weight% or less, or 50 weight% or less of the coating composition, based on the total solids weight of the coating composition. The binder can comprise an amount within a range, for example, of from 10 weight% to 70 weight %, or from 20 weight% to 60 weight%, or from 30 weight% to 50 weight% of the coating composition, based on the total solids weight of the coating composition.

The retroreflective powder coating composition further comprises a plurality of particles that are mixed with the binder. At least some of the particles provide retroreflective properties. That is, at least some of the particles reflect incident light back in the direction of the light source distributing incident light.

The particles mixed with the binder of the powder coating composition that provide retroreflective properties can comprise glass particles, such as glass microspheres. The glass particles may be at least partially coated with a metallic material. Non-limiting examples of glass particles include barium titanate glass particles, soda lime glass particles, and combinations thereof. Other non-limiting examples include particles at least partially made from other types of clear glass and/or silica.

The particles are selected such that at least some of the particles are at least partially coated with a metallic material to provide desired retroreflective properties. A non-limiting example of a metallic material used to coat the particles is aluminum. The metallic material can be, for example, hemispherically coated over the particles. That is, the metallic material can be coated over at least half, but not the entire, surface of the particles. For instance, the particles can comprise particles that are hemispherically coated with aluminum.

It is appreciated that the plurality of particles can comprise a mixture of different types of particles such as different types of glass particles. For example, the plurality of particles can comprise a combination of barium titanate glass particles at least partially coated with a metallic material (e.g. aluminum) and soda lime glass particles.

The particles can also be treated with an additional material that lowers the surface energy of the particles. For example, the particles coated with the metallic material as previously described can be further coated with an additional material that lowers the surface energy below the surface tension of the binder materials (e.g. the film-forming resin and/or optional crosslinker) when in the molten state during the curing process, and optionally below the surface energy and/or surface tension of other components that may be in the coating composition.

As used herein, “surface tension” refers to the physical property equal to the amount of force per unit area necessary to expand the surface of a liquid. Although numerically equivalent of liquid surface tension, surface energy is used to describe a solid. Whether the additional material lowers the surface energy of the particle can be determined by measuring surface energy according to ASTM D7490-13 using a Kruss DSA100 analyzer.

The particles can, for example, be coated with an organic material. As used herein, an “organic material” refers to a compound that contains carbon atoms and optionally one or more other atoms. The organic material can be at least partially coated over a portion of the surface of the particles. Non-limiting example of organic materials that can be coated over the surface of the particles include a silane material such as an alkoxysilane (for example, alkyl trialkoxysilanes), a fluorinated material such a fluoropolymer, or a combination thereof.

It is appreciated that the particles can be coated with both a metallic material and an additional material that lowers the surface energy as previously described. For instance, the plurality of particles can comprise glass particles, such as barium titanate glass particles, hemispherically coated with a metallic material and at least partially coated with an additional material, such as an organic material.

The retroreflective powder coating composition may comprise particles that are not coated with a metallic material or an additional material that lowers a surface energy of the particles. Such particles may comprise glass particles, such as glass microspheres. The glass microspheres may comprise soda lime glass microspheres. The inclusion of such particles may further enhance the retroflectivity of the coating.

The various types of particles described herein can comprise various shapes and sizes. For instance, the particles can comprise microspheres. The particles can also comprise a particle size of at least 1 micron, at least 5 microns, or at least 10 microns. The particles can also comprise a particle size of up to 500 microns, such as up to 200 microns, up to 100 microns, up to 80 microns, or up to 60 microns. The particles can comprise a particle size range of from 1 micron to 500 microns, from 5 to 200 microns, from 1 to 100 microns, from 5 to 100 microns, from 5 microns to 80 microns, or from 10 microns to 60 microns. The particle sizes can be determined by visually examining a micrograph of a transmission electron microscopy (“TEM”) image, measuring the diameter of the particles in the image, and calculating the particle size of the measured particles based on magnification of the TEM image.

The particles can also be selected such that at least some of the particles have a refractive index of greater than 1.5, or 1.8 or greater, or 1.9 or greater, or 2.0 or greater. As used herein, “refractive index” refers to the change in direction (i.e. apparent bending) of a light ray passing from one medium to another. The refractive index can be measured using a refractometer such as a Bausch and Lomb Refractometer.

The plurality of particles can comprise at least 1 weight%, at least 5 weight%, at least 20 weight %, at least 30 weight, or at least 40 weight% of the coating composition, based on the total solids weight of the coating composition. The plurality particles can comprise 80 weight% or less, 70 weight% or less, or 60 weight% or less of the coating composition, based on the total solids weight of the coating composition. The plurality of particles can comprise an amount within a range, for example, of from 1 weight% to 80 weight%, or from 5 weight % to 80 weight%, or from 20 weight% to 80 weight%, or from 30 weight% to 70 weight%, or from 40 weight% to 60 weight% of the coating composition, based on the total solids weight of the coating composition.

The retroreflective powder coating composition can also include other optional materials. For example, the retroreflective powder coating composition can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes such as metallic flakes or micas. A single colorant or a mixture of two or more colorants can be used in the coatings of the present invention.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, phthalo green or blue, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

Other non-limiting examples of components that can be used with the retroreflective powder coating composition of the present invention include plasticizers, abrasion resistant particles, fillers including, but not limited to, micas, talc, clays, and inorganic minerals, anti-oxidants, hindered amine light stabilizers, UV light absorbers and stabilizers, surfactants, flow and surface control agents, thixotropic agents, catalysts, reaction inhibitors, corrosion-inhibitors, and other customary auxiliaries.

The coating composition can include any of the previously described optional components to provide or adjust one or more properties in the final coating. For example, the coating composition can further include one or more additional particles that are different from the previously described retroreflective particles and which can reflect light at various angles, such as at two or more different angles (e.g. at a 90 degree angle and one or more additional angles). Non-limiting examples of such additional particles include metallic particles, wherein the metallic particles comprise aluminum, silver, copper, bronze, stainless steel, zinc, or a combination thereof. Non-limiting examples of such additional particles include mica or pearlescent pigments, glass-containing effect pigments, or a combination thereof.

The retroreflective powder coating composition can also be free of any of the previously described optional components. For example, the retroreflective powder coating composition can be substantially free, essentially free, or completely free of a flow control agent. As used herein, a “flow control agent” refers to a compound that is added to a powder coating composition that controls the flow of the powder coating composition. Further, the term “substantially free” as used in this context means the powder coating composition contains less than 1000 parts per million (ppm), “essentially free” means less than 100 ppm, and “completely free” means less than 20 parts per billion (ppb) of a flow control agent, based on the total weight of the powder coating composition. A non-limiting example of a flow control agent is RESIFLOW PL200A, which is commercially available from Estron Chemical.

The retroreflective powder coating composition may comprise a flow control agent when also including particles that are coated with the additional material that lowers a surface energy of the particles.

The binder, particles, and other optional components previously described can be selected to increase the amount of metallically coated retroreflective particles located in the surface region of the coating layer formed from the retroreflective powder coating composition, thereby improving the retroreflective properties in the final coating layer. For example, the binder, particles that provide retroreflective properties, and other optional components can be selected such that a surface region of the coating layer applied to a substrate has a greater concentration of the retroreflective particles than a bulk region of the coating layer. As used herein, the “surface region” means the region that is generally parallel to the exposed air-surface of the coated substrate and which has thickness generally extending perpendicularly from the surface of the coating beneath the exposed surface. A “bulk region” of the coating means the region which extends beneath the surface region and which is generally parallel to the surface of the coated substrate.

It was found that formulating a coating composition having a glass plate flow (GPF) of 40 mm or less, such as 25 mm or less, before addition of the plurality of particles, can increase the amount of retroreflective particles in the final coating composition located in the surface region of the coating layer formed from the retroreflective powder coating composition. The glass plate flow (GPF) is determined in accordance with ASTM D4242-07(2017), Standard Method for Inclined Plate Flow for Thermosetting Coating Powders.

The above-mentioned glass plate flow (GPF) of 40 mm or less, such as 25 mm or less, can be measured before addition of the plurality of particles to the coating composition. This measured composition may include the resinous components of the composition and may optionally include pigments and other additives (e.g., flow and leveling control agents, plasticizer, etc.) of the coating composition; however, this measured composition may exclude the previously-described plurality of particles and additional particles, which may be post-added to the measured composition.

The surface energy of the particles that provide retroreflective properties can also be lowered to increase the amount of retroreflective particles located in the surface region of the coating layer formed from the retroreflective powder coating composition. For example, the particles that provide retroreflective properties can be coated with the previously described additional material (e.g. a silane such as an alkyl alkoxysilane or a fluorinated material) to lower the surface energy of the particles below the surface energy and/or surface tension of the other components of the powder coating composition. As a result, the particles that provide retroreflective properties migrate to the surface of the coating layer (i.e., move through the bulk region to the surface region) such that a greater concentration of the particles can be found in the surface region.

It is appreciated that the retroreflective powder coating composition can be formed from components that provide a glass plate flow (GPF) of 40 mm or less, such as 25 mm or less before addition of the plurality of particles, and which also utilize retroreflective properties with a lowered surface energy as previously described. As such, the retroreflective powder coating composition can comprise a low flow and/or retroreflective particles with a lowered surface energy.

The retroreflective powder coating composition can be prepared by mixing the binder, retroreflective particles, optional additional particles, and optional additional components using art-recognized techniques and equipment such as with a Prism high speed mixer for example. For instance, the binder and other optional components can be mixed together without the retroreflective particles. The mixture is then melted and further mixed. The mixture can be melted with a twin screw extruder or a similar apparatus known in the art. During the melting process, the temperatures will be chosen to melt mix the solid mixture without curing the mixture. After melt mixing, the mixture is cooled and re-solidified. The re-solidified mixture is then ground such as in a milling process to form a solid particulate powder coating composition. The powder coating composition can then be mixed with the retroreflective particles to form the final retroreflective powder coating composition.

Alternatively, the binder and other optional components can be mixed together with the retroreflective particles prior to melting the mixture. In another example, the retroreflective particles can be bonded (using heat and/or shear) to the ground powder comprising the binder and other optional components.

It is appreciated that the binder, retroreflective particles, and other optional materials are mixed together according to any one of the previously described methods to form the coating composition and then applied to a substrate. That is, the binder, retroreflective particles, and other optional materials can be applied together over the substrate in a single application step. The retroreflective particles (and other optional particles) therefore do not need to be post-added after application of the powder coating composition such as when the powder coating composition is in the melted state.

The retroreflective powder coating composition can then be applied to a wide range of substrates known in the coatings industry. The substrate according to the present invention can be selected from a wide variety of substrates and combinations thereof. Non-limiting examples of substrates include vehicles and automotive substrates, industrial substrates, marine substrates and components such as ships, vessels, and on-shore and off-shore installations, storage tanks, packaging substrates, aerospace components, wood flooring and furniture, fasteners, coiled metals, heat exchangers, vents, an extrusion, roofing, wheels, grates, belts, conveyors, grain or seed silos, wire mesh, bolts or nuts, a screen or grid, HVAC equipment, frames, tanks, cords, wires, apparel, electronic components, including housings and circuit boards, glass, sports equipment, including golf balls, stadiums, buildings, bridges, containers such as a food and beverage containers, and the like. As used herein, “vehicle” or variations thereof includes, but is not limited to, civilian, commercial and military aircraft, and/or land vehicles such as airplanes, helicopters, cars, motorcycles, scooters, mopeds, and/or trucks. The shape of the substrate can be in the form of a sheet, plate, bar, rod or any shape desired.

The substrates, including any of the substrates previously described, can be metallic or non-metallic. Metallic substrates include, but are not limited to, tin, steel, cold rolled steel, hot rolled steel, steel coated with zinc metal, zinc compounds, zinc alloys, electrogalvanized steel, hot-dipped galvanized steel, galvanealed steel, galvalume, steel plated with zinc alloy, stainless steel, zinc-aluminum-magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

The retroreflective powder coating composition is particularly beneficial when applied to substrates associated with components that need to be easily seen under conditions of reduced visibility, such as nighttime conditions and/or inclement weather conditions. For example, the retroreflective powder coating composition is particularly beneficial when applied to traffic signs including poles and other components that hold and display the signs, road markings including guardrails, bicycles, scooters, automotive components and parts, and the like in order to improve visibility of the coated components under conditions of reduced visibility (e.g. at night by oncoming drivers).

The retroreflective powder coating composition of the present invention can be applied by any means standard in the art, such as spraying, electrostatic spraying, and the like. The retroreflective powder coating composition is typically a curable powder coating composition. As used herein, the terms “curable”, “cure”, and the like, as used in connection with a retroreflective powder coating composition, means that at least a portion of the components that make up the powder coating composition are polymerizable and/or crosslinkable including self-crosslinkable polymers.

The retroreflective powder coating composition of the present invention can be cured with heat, increased or reduced pressure, chemically such as with moisture, or with other means such as actinic radiation, and combinations thereof. The term “actinic radiation” refers to electromagnetic radiation that can initiate chemical reactions. Actinic radiation includes, but is not limited to, visible light, ultraviolet (UV) light, infrared radiation, X-ray, and gamma radiation. The retroreflective powder coating composition may be cured by applying ultraviolet radiation to the coating composition to form a cured coating. The retroreflective powder coating composition may be cured by applying heat to the coating composition to form a cured coating, such as by a convection oven, an infrared oven, a gas-fired oven and/or some combination thereof.

The retroreflective powder coating composition may be cured by laser curing. Curing the retroreflective powder coating composition by laser curing may be particularly beneficial when applying the retroreflective powder coating composition over heat sensitive substrates, such as plastics, so as to avoid damaging the underlying substrate by the curing process.

The coatings formed from the coating compositions of the present invention can be applied to a dry film thickness of 20 to 1000 microns, 30 to 300 microns, or 50 to 150 microns. The dry film thickness may be larger than a diameter of the particles and additional particles such that the particles and additional particles do not protrude from the dry film layer.

The coating composition can be applied to a substrate to form a monocoat. As used herein, a “monocoat” refers to a single layer coating system that is free of additional coating layers. Thus, the coating composition can be applied directly to a substrate and cured to form a single layer coating, i.e. a monocoat. When the retroreflective powder coating composition is applied to a substrate to form a monocoat, the coating composition can include additional components to provide other desirable properties. For example, the retroreflective powder coating composition can also include an inorganic component that acts as a corrosion inhibitor. As used herein, a “corrosion inhibitor” refers to a component such as a material, substance, compound, or complex that reduces the rate or severity of corrosion of a surface on a metal or metal alloy substrate. The inorganic component that acts as a corrosion inhibitor can include, but is not limited to, an alkali metal component, an alkaline earth metal component, a transition metal component, or combinations thereof.

Alternatively, the curable coating composition can be applied over a first coating layer deposited over a substrate to form a multi-layer coating system. For example, a coating composition can be applied to a substrate as a primer layer and the retroreflective powder coating composition previously described can be applied over the primer layer as a topcoat. As used herein, a “primer” refers to a coating composition from which an undercoating may be deposited onto a substrate in order to prepare the surface for application of a protective or decorative coating system. A basecoat can also be used with the multi-layer coating system. A “basecoat” refers to a coating composition from which a coating is deposited onto a primer and/or directly onto a substrate, optionally including components (such as pigments) that impact the color and/or provide other visual impact, and which may be overcoated with the retroreflective powder coating previously described. A clearcoat layer may be applied over the retroreflective coating layer formed from the retroreflective powder coating composition for further improved weatherability and/or durability of the coated substrate.

It was found that the retroreflective powder coating compositions of the present invention provide good retroreflective properties when applied to a substrate and cured to form a coating. For example, a coating formed from the retroreflective coating composition can exhibit a coefficient of retroreflection (R_{A}) of at least 3.5 cd/fc/ft, such as at least 4.5 cd/fc/ft, at least 10 cd/fc/ft, at least 15 cd/fc/ft, or at least 20 cd/fc/ft, as determined by ASTM E1709 with an observation angle of 0.2° and entrance angle of -4°.

### EXAMPLES

The following examples are presented to demonstrate the general principles of the invention. The invention should not be considered as limited to the specific examples presented. All parts and percentages in the examples are by weight unless otherwise indicated.

### Examples 1-6

### Preparation of Milled Powder Pigment Mixtures

Various milled powder pigment mixtures were prepared as described below.

Part A: Milled powder pigment mixtures were first prepared from the components listed in Table 1.

TABLE 1

| Component | Example 1 | Example 2 | Example 3 | Example 4 | Example 5 | Example 6 |
|---|---|---|---|---|---|---|
| CRYLCOAT 2437-0¹ | 450 | 412 | 435 | 558 | - | - |
| ISOCRYL EP-575² | 150 | 138 | 145 | - | - | - |
| TIONA 596³ | 400 | 400 | 400 | 400 | 400 | 400 |
| BENZOFLEX 352⁴ | - | 50 | - | - | - | - |
| RESIFLOW PL-200A⁵ | - | - | 20 | - | - | - |
| TGIC⁶ | - | - | - | 42 | - | - |
| CRYLCOAT E 04824⁷ | - | - | - | - | 557 | - |
| LUNAMER 552⁸ | - | - | - | - | 43 | - |
| CRYLCOAT 2890-0⁹ | - | - | - | - | - | 300 |
| POLYMAC 3110¹⁰ | - | - | - | - | - | 96 |
| CRELAN EF403¹¹ | - | - | - | - | - | 204 |
| GPF¹² (mm) | 23 | 42 | 23 | 135 | 23 | 26 |

¹ A TMA-free, carboxyl functional polyester resin, commercially available from Allnex (Frankfurt, Germany).
² A glycidyl functional acrylic copolymer, commercially available from Estron Chemical (Calvert City, KY).
³ A titanium dioxide pigment, commercially available from Cristal Global (Jeddah, Saudi Arabia).
⁴ A plasticizing additive, 1,4-cyclohexane dimethanol dibenzoate, commercially available from Eastman Chemical Company (Kingsport, TN).
⁵ Acrylic/silica flow and leveling control agent, commercially available from Estron Chemical (Calvert City, KY).
⁶ Triglycidyl isocyanurate crosslinker, commercially available from Wujin Nuitang Chemical (Jiangsu, China).
⁷ A carboxyl functional polyester resin, commercially available from Allnex (Frankfurt, Germany).
⁸ Hydroxyalkylamide crosslinker, commercially available from DKSH (Mount Olive, NJ).
⁹ A hydroxylated polyester resin, commercially available from Allnex (Frankfurt, Germany).
¹⁰ A hydroxyl-terminated polyester resin, commercially available from Polynt Composites (Scanzorosciate, Italy).
¹¹ A cycloaliphatic polyuretdione, commercially available from Covestro (Leverkusen, Germany).
¹² Glass Plate Flow per ASTM D4242-07 with the following procedure description: A pellet of the press molded composition was placed on a preheated level glass plate in an oven at 300° F. (149° C.). After the door was closed for 1 minute, the glass plate was tilted up to an angle of 65°. After an additional 29 minutes in the oven, the glass plate was removed and the length of flow was measured.

Each of the components listed in Table 1 for Examples 1-6 were weighed in a plastic bag and mixed by shaking vigorously in the same plastic bag for 30 seconds to form a dry homogeneous mixture. The mixture was melt mixed in a Theysohn 30 mm twin screw extruder with a moderately aggressive screw configuration and a speed of 500 RPM. The first extruder zone was set at 50° C., and the second zone was set to 100° C. The feed rate was such that a torque of 30-35% was observed on the equipment. The mixtures were dropped onto a set of chill rolls to cool and re-solidify the mixtures into solid chips. The chips were milled using a coffee grinder and sieved through a 104 micron screen to obtain a mass median diameter particle size of 35-40 microns. The resulting coating compositions for each of Examples 1-6 were solid particulate powder coating compositions that were free flowing. The Glass Plate Flow was measured per the procedure described above on the relevant examples, and the values are noted at the bottom of Table 1.

### Examples 7-17

### Preparation of Powder Coating Compositions

Part B: Each of the solid particulate milled powder pigment mixtures prepared in Part A were dry blended using the following components in Table 2.

Each of the solid particulate powder coating compositions of Examples 7-17 were electrostatically applied over several 0.025 inch by 3 inch by 6 inch aluminum panels. During application, a layer of 2.5 to 4.5 mils (64-114 microns) was applied and baked in a conventional oven at 400° F. (204° C.) for 10 minutes. The Coated aluminum panels were evaluated for Coefficient of Retroreflection (R_{A}) per the test method described below.

TABLE 2

| Component | Ex.7 | Ex.8 | Comp. Ex. 9 | Ex.10 | Ex. 11 | Comp. Ex.12 | Ex.13 | Ex.14 | Ex.15 | Ex.16 | Ex.17 |
|---|---|---|---|---|---|---|---|---|---|---|---|
| Composition of Example 1 | 500 | 500 | - | - | - | - | - | - | - | 700 | 500 |
| Composition of Example 2 | - | - | 500 | 500 | - | - | - | - | - | - | - |
| Composition of Example 3 | - | - | - | - | 500 | - | - | - | - | - | - |
| Composition of Example 4 | - | - | - | - | - | 500 | 500 | - | - | - | - |
| Composition of Example 5 | - | - | - | - | - | - | - | 500 | - | - | - |
| Composition of Example 6 | - | - | - | - | - | - | - | - | 500 | - | - |
| PRIZMALITE P2453BTA¹³ | 500 | - | 500 | - | 500 | 500 | - | - | - | 300 | 300 |
| PRIZMALITE P2453BTA (silane)¹⁴ | - | 500 | - | 500 | - | - | 500 | 500 | 500 | - | - |
| PRIZMALITE P2050SL¹⁵ | - | - | - | - | - | - | - | - | - | - | 200 |
| Coefficient of Retroreflection (R_{A}) cd/fc/ft² | | | | | | | | | | | |
| R_{A} (0.2° observation)¹⁶ | 11.5 | 25 | 3.2 | 38.1 | 3.7 | 1.1 | 18.1 | 28.6 | 37.2 | 5.1 | 9.6 |

¹³ Hemispherically aluminum coated barium titanate glass microspheres, commercially available from Prizmalite (New York, NY).
¹⁴ Hemispherically aluminum coated barium titanate glass microspheres that are further coated with alkyl trialkoxysilane, commercially available from Prizmalite (New York, NY).
¹⁵ Soda lime glass microspheres, commercially available from Prizmalite (New York, NY).
¹⁶ Coefficient of Retroreflection (R_{A}) using a retroreflectometer compliant to ASTM E1709-08 (Standard Test Method for Measurement of Retroreflective Signs) at a 0.2 degree observation angle and entrance angle of -4°.

As can be seen from Table 2, Examples 7, 8, 10, 11, and 13-17 have an improved coefficient of retroreflection compared to Comparative Examples 9 and 12 which do not include the coating composition before the addition of the plurality of particles having a glass plate flow of 40 mm or less, such as 25 mm or less, and/or at least a portion of the particles being coated with an additional material that lowers a surface energy of the particles.

Whereas particular embodiments of this invention have been described above for purposes of illustration, it will be evident to those skilled in the art that numerous variations of the details of the present invention may be made without departing from the invention as defined in the appended claims.

1. A retroreflective powder coating composition, comprising:
(a) binder comprising a film-forming resin; and
(b) a plurality of particles in which at least a portion of the particles comprise particles at least partially coated with a metallic material,
wherein, (i) the powder coating composition has a glass plate flow of 40 mm or less, such as 25 mm or less, before addition of the plurality of particles; and/or (ii) at least a portion of the particles are further coated with an additional material that lowers a surface energy of the particles.

2. The retroreflective powder coating composition of claim 1, wherein the powder coating composition has the glass plate flow of 40 mm or less, such as 25 mm or less, before addition of the plurality of particles.

3. The retroreflective powder coating composition claim 1, wherein at least a portion of the particles are further coated with the additional material that lowers a surface energy of the particles.

4. (canceled)

5. The retroreflective powder coating composition of claim 1, wherein the additional material comprises a silane containing material.

6. (canceled)

7. The retroreflective powder coating composition of claim 1, wherein at least some of the particles have a refractive index of greater than 1.5.

8. The retroreflective powder coating composition of claim 1, wherein the particles comprise barium titanate glass particles at least partially coated with the metallic material.

9. The retroreflective powder coating composition of claim 1, wherein the particles at least partially coated with a metallic material comprise an amount within a range of from 1 weight% to 80 weight%, such as from 20 weight% to 80 weight%, based on the total solids weight of the powder coating composition.

10. The retroreflective powder coating composition of claim 1, wherein the powder coating composition is a thermoset powder coating composition.

11. The retroreflective powder coating composition of claim 10, wherein the binder further comprises a crosslinker reactive with the film-forming resin.

12. The retroreflective powder coating composition of claim 11, wherein the film-forming resin comprises a carboxylic acid functional polyester, and the crosslinker comprises an epoxy functional addition polymer.

13. The retroreflective powder coating composition of claim 11, wherein the film-forming resin comprises a hydroxyl functional polyester, and the crosslinker comprises a blocked isocyanate.

14. The retroreflective powder coating composition of claim 11, wherein the film-forming resin comprises a polyester polymer and the crosslinker comprises a triglycidyl isocyanurate crosslinker, a hydroxyalkylamide crosslinker, a glycidyl functional acrylic copolymer crosslinker, or a combination thereof.

15. The retroreflective powder coating composition of claim 11, wherein the film-forming resin comprises an epoxy, a polyester and epoxy blend, a fluoropolymer, a silicone-containing polymer, or a combination thereof.

16. (canceled)

17. The retroreflective powder coating composition of claim 1, wherein the powder coating composition is substantially free of a flow control agent.

18. (canceled)

19. The retroreflective powder coating composition of claim 1, wherein the particles further comprise additional particles that are different from the particles at least partially coated with a metallic material and which reflect light at two or more different angles, wherein the additional particles comprise metallic particles, mica or pearlescent pigments, glass-containing effect pigments, or a combination thereof.

20. The retroreflective powder coating composition of claim 19, wherein the metallic particles comprise aluminium, silver, copper, bronze, stainless steel, zinc, or a combination thereof.

21. The retroreflective powder coating composition of claim 1, further comprising particles that are not coated with a metallic material or an additional material that lowers a surface energy of the particles.

22. A substrate at least partially coated with a coating formed from the powder coating composition of claim 1.

23. The substrate of claim 22, wherein the substrate comprises a metallic material or a plastic material.

24. (canceled)

25. The substrate of any of claim 22, wherein the coating formed from the powder coating composition exhibits a coefficient of retroreflection (R_{A}) of at least 3.5 cd/fc/ft in accordance with ASTM E1709 with an observation angle of 0.2° and entrance angle of -4°.

26. The substrate of claim 25, wherein particles are not post-added after application of the powder coating composition.

27. The substrate of any of claim 22, wherein the substrate comprises a vehicle component, a sign, a road marking, and/or a railing.

28-30. (canceled)

31. A method of forming a coating over at least a portion of a substrate comprising:
(a) applying a powder coating composition according to claim 1 over at least a portion of a substrate such that the binder and plurality of particles are applied together over the substrate during step (a); and
(b) curing the powder coating composition after step (a) to form a coating,
wherein the coating exhibits a coefficient of retroreflection (R_{A}) of at least 3.5 cd/fc/ft² in accordance with ASTM E1709-08 with an observation angle of 0.2° and entrance angle of -4°.
